(19) United States
(12) Patent Application Publication
(10) Pub. No.: US 2014/0067336 A1
(43) Pub. Date: Mar. 6, 2014

(54) SYSTEM AND METHOD FOR DEVELOPING A DESIGN AND PRICE OF A PANEL STRUCTURE

(71) Applicant: KYSOR PANEL SYSTEMS DIVISION OF WELBILT WALKINS LP, FORTH WORTH, TX (US)

(72) Inventors: David C. JOHNSON, AZLE, TX (US); Josh CHAN, IRVING, TX (US); Ron L. DAGDAG, EULESS, TX (US); Monte L. HALL, GRAPEVINE, TX (US); Stephen HOUSTON, Keller, TX (US)

(73) Assignee: KYSOR PANEL SYSTEMS DIVISION OF WELBILT WALKINS LP, FORTH WORTH, TX (US)

(21) Appl. No.: 14/015,483

(22) Filed: Aug. 30, 2013

Related U.S. Application Data
(60) Provisional application No. 61/696,086, filed on Aug. 31, 2012.

(51) Int. Cl. G06F 17/50

(52) U.S. Cl. CPC G06F 17/50
USPC 703/1

(57) ABSTRACT

A system and method for producing a quote for an insulated panel structure. The system comprises a user terminal device in communication with one or more computing devices. The user terminal device includes a sketch facility that enables a user to interactively develop a sketch of a design of said insulated panel structure on a display of the user terminal device. An optimizing program and an auto-design program run on the computing devices and provide an optimization of the design and an engineering drawing of the design to the user terminal device for incorporation into the quote.

### RELATED APPLICATION

This application claims priority of U.S. Provisional Patent Application No. 61/696,086, filed on Aug. 31, 2012, the entire contents of which are hereby incorporated herein by reference.

### FIELD OF THE DISCLOSURE

This disclosure relates to a system and method for developing a design of an insulated panel structure and a price estimate based on descriptive inputs from a user.

### BACKGROUND OF THE DISCLOSURE

Insulated panel structures are used in various industries including shipping, food service, industrial, scientific, grocery supermarket, convenience store, floral document storage, cold storage and others. For example, in the food service industry, walk-in refrigerated structures are constructed with insulated panels. A known way of quoting, describing and communicating an offer for a structure made from insulated panels is usually an inexact science of approximating prices and costs without really knowing any challenges in engineering the size and shape, and how the panels would be manufactured to create that structure. Options, accessories, computations for BTU loads and refrigeration sizing, materials required are all very technical, and not readily achievable by laypersons or sales persons, really requiring an engineer to do the manual computations.

Thus, there is a need for an improved system and method for modeling a rendition of a design of an insulated panel structure and for providing a price estimate for the design.

### SUMMARY OF THE DISCLOSURE

In an embodiment of a system according to the present disclosure, the system comprises one or more user terminal devices that interact via a network with one or more computing devices and with a user to execute program instructions to provide a sketch of the insulated panel structure, and to provide, based on the sketch, a construction plan.

In another embodiment of the system according to the present disclosure, a first one of the terminal devices comprises a user interface with a display and tools for the user to draw the sketch including walls, tops, or floors to form one or more rooms of the insulated panel structure.

In another embodiment of the system according to the present disclosure, the program instructions comprise sketch instructions that, when executed, (a) enable the user to select and apply features to the sketch and (b) compute joints, angles, snap lines of the sketch.

In another embodiment of the system according to the present disclosure, the features include one or more of doors, ramps, buyout doors, windows, hatches and openings for the insulated panel structure.

In another embodiment of the system according to the present disclosure, the program instructions, when executed, develop the construction plan for the sketch in which manufacturing rules are applied to the sketch to determine a panel layout for least cost for all manufactured features. The construction plan and the panel layout are optimized by identifying parts, panels and accessories for creating the insulated panel structure and by determining costs and prices for the parts and panels, shipping and tax charges.

In another embodiment of the system according to the present disclosure, the sketch comprises walls, tops, floors or features or accessories. The program instructions, when executed, create a data document that comprises a manufacturing plan for the walls, tops, floors or features or accessories.

In another embodiment of the system according to the present disclosure, the construction plan and panel layout are further optimized by considering the altitude of the site where the insulated panel structure will be located and by selecting the parts and panels based on the altitude.

In another embodiment of the system according to the present disclosure, there is further provided, based on the construction plan, an engineering drawing, and to provide, based on the engineering drawing, manufacturing orders for the insulated panel structure.

In another embodiment of the system according to the present disclosure, the program instructions, when executed, create the engineering drawing by importing prototypes for parts listed in the data document, filling in parameters and properties of the prototypes of the parts, creating layout drawings, installation instructions, door sheets and refrigeration sheets.

In another embodiment of the system according to the present disclosure, the program instructions, when executed, create manufacturing orders with a bill of materials, hardware box plans and submission files for the insulated panel structure.

In another embodiment of the system according to the present disclosure, the insulated panel structure comprises a refrigerated walk in structure.

In an embodiment of a method according to the present disclosure, a design for an insulated panel structure is created by:

executing program instructions to provide a sketch of the insulated panel structure; and

executing program instructions to provide, based on the sketch, a construction plan for the insulated panel structure.

In another embodiment of the method according to the present disclosure, the method further comprises: executing the program instructions to interact with a user to draw the sketch including walls, tops, or floors to form one or more rooms of the insulated panel structure.

In another embodiment of the method according to the present disclosure, the method further comprises: executing the program instructions for (a) enabling the user to select and apply features to the sketch and (b) computing joints, angles, snap lines of the sketch.

In another embodiment of the method according to the present disclosure, the features include one or more of doors, ramps, buyout doors, windows, hatches and openings for the insulated panel structure.

In another embodiment of the method according to the present disclosure, the method further comprises: executing the program instructions to provide, based on the sketch, a panel layout for the insulated panel structure and to optimize the construction plan and the panel layout by identifying parts, panels and accessories for creating the insulated panel structure and by determining costs and prices for the parts and panels, shipping and tax charges.

In another embodiment of the method according to the present disclosure, the construction plan and panel layout are further optimized by considering the altitude of the site where the insulated panel structure will be located and by selecting the parts and panels based on the altitude.

In another embodiment of the method according to the present disclosure, the method further comprises: executing the program instructions for creating a data document that comprises a manufacturing plan for the walls, tops, floors or features or accessories.

In another embodiment of the method according to the present disclosure, the method further comprises: executing program instructions to provide, based on the construction plan, an engineering drawing; and executing program instructions to provide, based on the engineering drawing, manufacturing orders for the insulated panel structure.

In another embodiment of the method according to the present disclosure, the method further comprises: executing the program instructions for creating the engineering drawing by importing a prototype for parts listed in the data document, filling in parameters and properties of the prototype of the parts, creating layout drawings, installation instructions, door sheets and refrigeration sheets.

In another embodiment of the method according to the present disclosure, the method further comprises: executing the program instructions for creating manufacturing orders with a bill of materials, hardware box plans and submission files.

In another embodiment of the method according to the present disclosure, the insulated panel structure comprises a refrigerated walk-in structure.

In an embodiment of the user terminal device according to the present disclosure, the user terminal device comprises a display and an input facility for the user to interactively input data concerning the insulated panel structure via the display and to develop on the display a sketch of an insulated panel structure. A sketch facility, based on the input data, provides on the display an elevational view of the sketch.

In another embodiment of the user terminal device according to the present disclosure, the sketch facility, based on the input data, automatically changes a height of a wall in the elevational view to match a dimension of available insulated panels.

In an embodiment of the user terminal device according to the present disclosure, the sketch facility, based on the input data, adds to the elevational view one or more features comprising a door, a ramp, a window, a hatch, an opening, a top, a floor and accessories.

In an embodiment of the user terminal device according to the present disclosure, the sketch facility, based on the input data, enables the user to identify a location on the sketch for placement of one or more of the features.

In an embodiment of a method according to the present disclosure for developing a design of an insulated panel structure, the method comprises:

interactively with a user terminal inputting data concerning the insulated panel structure via a display of the user terminal;

sketching on the display a sketch of an insulated panel structure; and

providing on the display an elevational view of the sketch.

In another embodiment of the method according to the present disclosure, the method further comprises: automatically changing a height of a wall in the elevational view to match a dimension of available insulated panels.

In another embodiment of the method according to the present disclosure, the method further comprises: adding to the elevational view one or more features comprising a door, a ramp, a window, a hatch, an opening, a top, a floor and accessories.

In another embodiment of the method according to the present disclosure, the method further comprises: enabling the user to identify a location on the sketch for placement of one or more of the features.

In an embodiment of a computer readable medium according to the present disclosure, the medium stores one or more programs for a system that develops a design for an insulated panel structure. The memory media comprises: executable with a computer apparatus instructions of the one or more programs to provide a sketch of the insulated panel structure, and to provide, based on the sketch, a construction plan.

In another embodiment of a computer readable medium according to the present disclosure, further comprising: executable with the computer apparatus instructions of the one or more programs to interact with a user to draw the sketch including walls, tops, or floors to form one or more rooms of the insulated panel structure.

In another embodiment of a computer readable medium according to the present disclosure, further comprising: executable with the computer apparatus instructions of the one or more programs for (a) enabling the user to select and apply features to the sketch and (b) computing joints, angles, snap lines of the sketch.

In another embodiment of a computer readable medium according to the present disclosure, the features include one or more of doors, ramps, buyout doors, windows, hatches and openings for the insulated panel structure.

In another embodiment of a computer readable medium according to the present disclosure, further comprising: executable with the computer apparatus instructions of the one or more programs for applying manufacturing rules to the sketch to determine a panel layout for least cost for all manufactured features while providing the construction plan.

In another embodiment of a computer readable medium according to the present disclosure, further comprising: executable with the computer apparatus instructions of the one or more programs for creating a data document that comprises a manufacturing plan for the walls, tops, floors or features or accessories.

In another embodiment of a computer readable medium according to the present disclosure, further comprises: executable with the computer apparatus instructions of the one or more program to provide, based on the construction plan, an engineering drawing and to provide, based on the engineering drawing, manufacturing orders for the insulated panel structure.

In another embodiment of a computer readable medium according to the present disclosure, further comprising: executable with the computer apparatus instructions of the one or more programs for creating the engineering drawing by importing prototypes for parts listed in the data document, filling in parameters and properties of the prototypes of the parts, creating layout drawings, installation instructions, door sheets and refrigeration sheets.

In another embodiment of a computer readable medium according to the present disclosure, further comprising: executable with the computer apparatus instructions of the one or more programs for creating the manufacturing orders with a bill of materials, hardware box plans and submission files.

In an embodiment of a computer readable medium according to the present disclosure, the computer readable medium stores one or more programs for a system that develops a design for an insulated panel structure, the memory media comprising:

executable with a computer apparatus instructions of the one or more programs for the user to interactively input data concerning the insulated panel structure via a display and to develop on the display a sketch of an insulated panel structure; and

executable with the computer apparatus instructions of the one or more programs to provide, based on the input data, on the display an elevational view of the sketch.

In another embodiment of a computer readable medium according to the present disclosure, further comprising: executable with a computer apparatus instructions of the one or more programs for automatically changing a height of a wall in the elevational view to match a dimension of available insulated panels.

In another embodiment of a computer readable medium according to the present disclosure, further comprising: executable with a computer apparatus instructions of the one or more programs for adding to the elevational view one or more features comprising a door, a ramp, a window, a hatch, an opening, a top, a floor and accessories.

In another embodiment of a computer readable medium according to the present disclosure, further comprising: executable with a computer apparatus instructions of the one or more programs for enabling the user to identify a location on the sketch for placement of one or more of the features.

### BRIEF DESCRIPTION OF THE DRAWINGS

Other and further objects, advantages and features of the present disclosure will be understood by reference to the following specification in conjunction with the accompanying drawings, in which like reference characters denote like elements of structure and:

FIG. 1 is a block diagram of a system for providing a quote and design for an insulated panel structure according to the present disclosure;

FIG. 2 is a quote and design process lifecycle overview chart for the system of FIG. 1;

FIG. 3 is a quote process overview flow chart for the system of FIG. 1;

FIG. 4 is a block diagram of user terminal device of the system of FIG. 1;

FIGS. 5-16 are display screen views presented on the display of the user terminal device of FIG. 4;

FIG. 17 is a flow diagram for the quote/sketch program of the user terminal device of FIG. 4;

FIG. 18 is a flow diagram of the optimizer program of the system of FIG. 1; and

FIG. 19 is a flow diagram of the auto-design program of the system of FIG. 1.

### DESCRIPTION OF THE PREFERRED EMBODIMENT

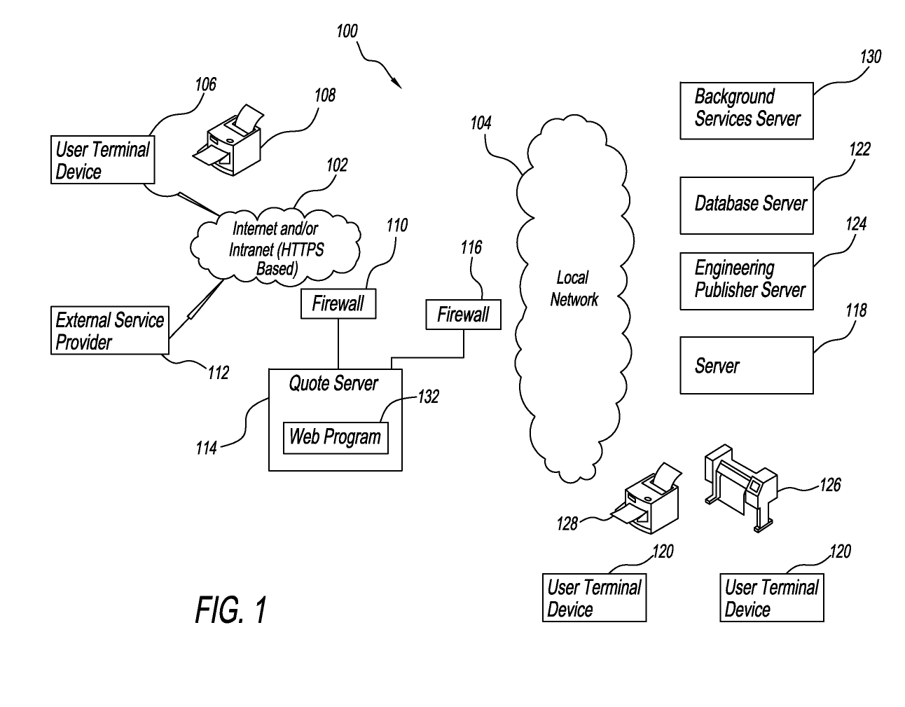

Referring to FIG. 1, a system 100 according to the present disclosure comprises a plurality of devices that communicate via a communication network 102 and a local network 104. One or more user terminal devices 106 are connectable to communication network 102. Also connectable to communication network 102 are an external service provider 112 and a fire wall 110. A fire wall 116 is connectable to local network 104. A quote server 114 is connectable to communication network 102 and local network 104 via firewall 110 and firewall 116, respectively. A printer/facsimile device 108 is connectable to user terminal device 106.

Local network 104 is connectable to a server 118, one or more user terminal devices 120, a database server 122, an engineering publisher server 124 and a special background services server 130. A printer/facsimile device 128 is connectable to user terminal devices 120. A printer 126 is connectable to user terminal devices 120.

User terminal devices 106 and 120, for example, may be a desktop or laptop personal computer, mobile telephone terminal, a PDA, or other suitable user interface device. In preferred embodiments, user terminal devices 106 and 120 are capable of executing programs that are assigned for their respective uses.

Communication network 102 may be any combination or implementation of communication schema to include Ethernet, token rings, copper, fiber, radio frequencies, and manually transported storage devices, and whatever other means that may successfully relay digital information (images, text, and related data) between the terminals and servers for salesperson, customers, agents, affiliates, technical staff and partners to participate in the communications, assembly of data required, and recipients of the resulting quotations, reports, analytical data, engineering and draft drawings. That is, the program code of system 100 may also be considered as a form of transmitted signal, such as a stream of data communicated via the Internet or any other type of communication network, including cellular radio communication networks of any kind, such as GSM/GPRS, UMTS, CDMA 2000 etc. A conventional web program 132 is stored in one or more servers connected to communication network 102. In a preferred embodiment, web program 132 is stored in quote server 114. In other embodiments program 132 may be stored in one or more servers connected to local network 104. Web program 132 when accessed by a user terminal launches or initiates one or more programs associated with the user terminal. Web program 132 may also provide or initiate a feature of a workflow routing mechanism or procedure for automatically tracking requests and status, such as requests from a quote user to an installation service provider for installing a refrigerated walk-in structure or to a drafting provider for drawing adjustments.

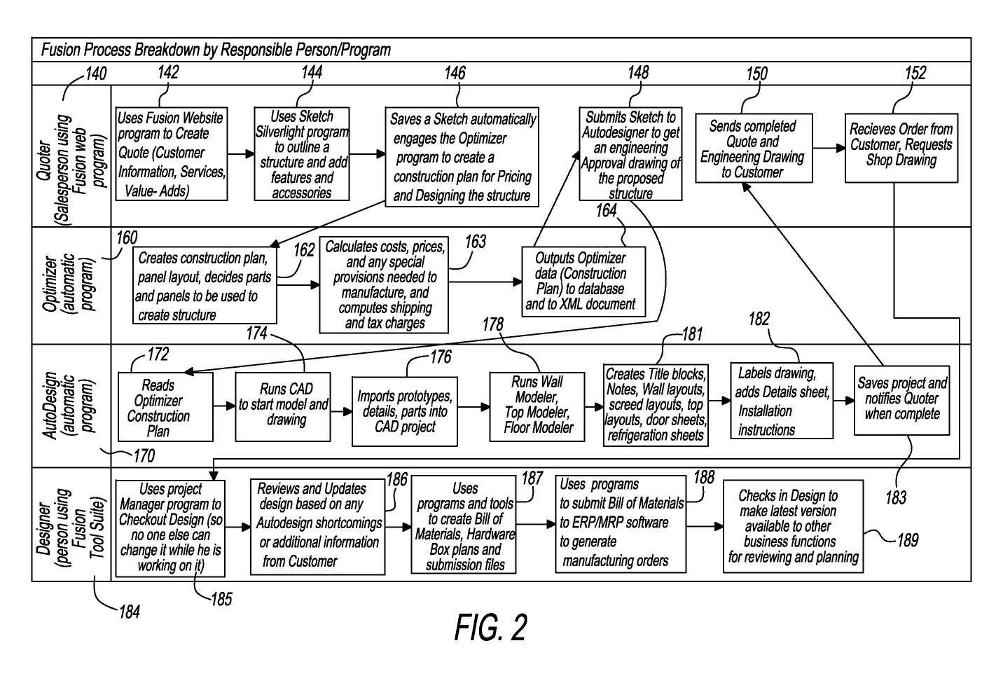

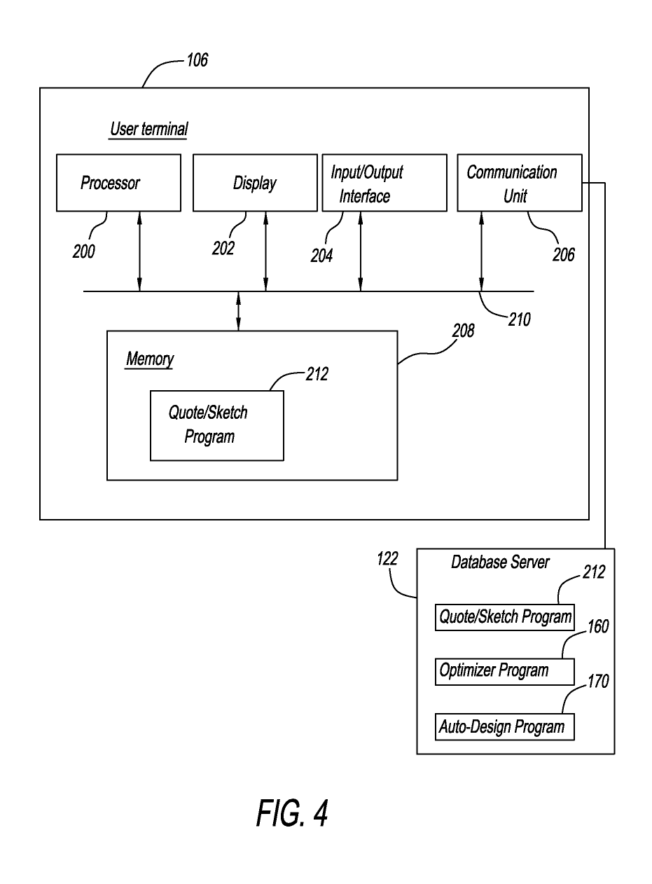

Referring to FIG. 2, system 100 is configured to perform a procedure of developing a design and price estimate for an insulated panel structure. The procedure employs a user or quoter 140, an optimizer program 160, an auto-design program 170 and a designer person 184. At box 142, quoter 140 uses user terminal device 106 access web program 132 to use and initiate a suite of programs to develop a design of the insulated panel structure. User terminal device 106 preferably comprises a web browser (not shown) to access web program 132 to assist in obtaining data from one or more of server 118, database server 122, and special background services server 130. At box 144, quoter 140 uses a quote/sketch program 212 (shown in FIG. 4) to outline and create a panel structure sketch and add features and accessories. Quoter 140 may also use web program 132 to add unsketched accessories, to collect and store documentation (for example, customer requests regarding the design) and to provide other features. At box 146, quoter 140 saves the panel structure sketch and engages web program 132 to launch or initiate optimizer program 160 to create a construction plan for pricing and designing the panel structure.

Optimizer program 160 can be executed by any server or computing device connected to communication network 102 or to local network 104. By way of example, optimizer program 160 will be considered as running on server 118. At box 162, optimizer program 160 responds to the request of the quote sketch program from box 146 to create or develop a construction plan and a panel layout and determines parts and panels to be used to construct the panel structure. At box 163, costs and prices are calculated for the parts of the panel structure, any special provisions needed to manufacture, shipping and tax charges. At this point, the optimizer program 160 may determine from customer information the location where the insulated panel structure will be installed to obtain the altitude, which can affect the cost of operation and selection of parts. At box 164, optimizer program 160 outputs the construction plan and data to quoter 140 at box 148 and to database server 122 (FIG. 2). The construction plan and data may be in an XML format.

At box 148, quote/sketch program 212 accesses web program 132 to submit the construction plan for the insulated panel structure to auto-design program 170 to get an engineering approval drawing of the insulated panel structure.

Auto-design program 170 can be executed by any server or computing device connected to communication network 102 or local network 104. By way of example, auto-design program 170 will be considering as running on one of the user terminal devices 120. Auto-design program 170 receives and reads the optimizer construction plan at box 172. At box 174, instructions of auto-design program 170 are executed to start a model and an engineering drawing. At box 176, instructions of auto-design program 170 are executed to import prototypes, details, parts into the construction plan for the insulated panel structure received from quoter 140. At box 178, instructions of auto-design program 170 are executed to provide models of walls, a top and a floor of the paneled structure, using computer aided design (CAD) software. At box 181, instructions of auto-design program 170 are executed to create title blocks, notes, screed layouts, top layouts, door sheets, refrigeration sheets and the like for the construction plan for the insulated panel structure provided from box 148 by quoter 140. At box 182, the engineering drawing is labeled and a details sheet and installation instructions are developed. At box 183, the project is saved to database server 122 and quoter 140 is notified of its completion.

At box 150, quoter 140 sends the completed quote and engineering drawing to the customer. Quoter 140 may at this point use web program 132 to route requests to service providers to obtain prices for installation, engineering of special or customized parts, review of the design, special enhancements and other services. When an authorized service provider accesses web program 132, a dashboard is presented for the service provider to access the data and documentation of the refrigerated walk-structure needed to provide the service. At box 152, quoter 140 receives an order from the customer and requests a shop drawing from design person 184.

Designer person 184 uses a manager program to check out the completed design from database server 122 so no one else can change it while it is being worked on at box 185. At box 186, designer person 184 reviews and updates the design based on any shortcomings of auto-design program 170 or additional information from the customer. At box 187, designer person 184 uses programs and tools to develop the shop drawing, including, a bill of materials, hardware box plans, construction and manufacturing information including labels and notes and submission files. By adding construction information at this point, interruption and delay of the manufacturing process to obtain missing data is avoided. At box 188, designer person 184 uses the programs to submit the bill of materials to accounting and production planning software (for example, ERP/MRP software) to generate manufacturing orders. At box 189, designer person 184 checks in the design to make the latest version available to authorized persons for review and planning.

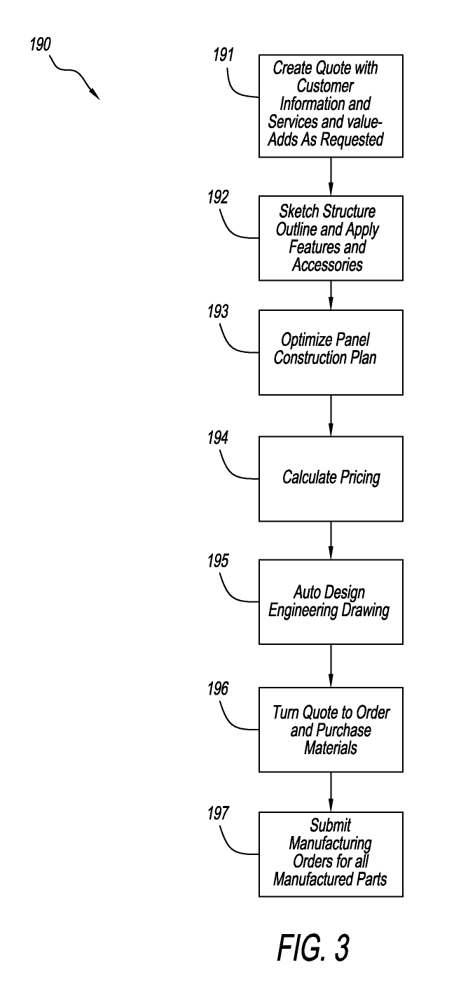

Referring to FIG. 3, a system flow diagram 190 depicts an overview of procedure for development of a design and a price estimate for an insulated panel structure. The procedure begins at start box 191 with quoter 140 using terminal device 106 to execute instructions of quote/sketch program 212 (FIG. 4) to create a quote with information, services and value-adds as requested and provided by the customer. At box 192, instructions are executed to sketch a panel structure outline and to apply features and accessories so as to develop a construction plan. At box 193, instructions of optimizer program 160 are executed to optimize the panel construction plan. At box 194, prices for the optimized construction plan are developed. At box 195, instructions of auto-design program 170 are executed to provide the engineering drawing of the construction plan. At box 196, designer person 184 develops an order to purchase materials. At box 197, designer person 184 submits manufacturing orders for all manufactured parts.

Referring to FIG. 4, a block diagram of a user terminal is shown, which can be used for user terminal devices 106 and 120. Since user terminal devices 106 and 120 are substantially alike, only user terminal device 106 will be described in detail. User terminal device 106 comprises a processor 200, a display 202, an input/output interface 204, a communication unit 206, and a memory 208 interconnected via a bus 210. Quote/sketch program 212 is stored in memory 208 or in a server, such as database server 122. Optimizer program 160 and auto-design program 170 are also shown as disposed in database server 122. Alternately, quote/sketch program 212, optimizer program 160 and auto-design program 170 can be disposed in the same or separate user terminals 106 and 120 or in separate servers connected to communication network 102 or local network 104.

In operation, processor 200 executes instructions of quote/sketch program 212 to present a series of display screens and/or dialog boxes on display 202 in an interactive session with a user. An input device (not shown), for example, a mouse, keyboard or other device, is used by the user to provide input to the display screens. In some embodiments a touch screen can be used. Input/output interface 204 interfaces to printer/facsimile device 108, the input devices for display 202 and other peripheral devices (not shown). Communication unit 206 includes devices for communication via communication network 102, such as a web browser, a modem and the like.

The instructions of quote/sketch program 212 to the respective devices depicted in the computer network cause the images of the ensuing figures to be rendered, displayed and made functional such that a human operator, such as quoter 140 may make requests of the system and be presented with questionnaires, data entry screens and/or dialog boxes and graphical and textual results, all of which may be comprised and understood as a cyclical iterative operation for establishing the detailed descriptions, price quotations, engineering computations and drafting depictions, such that the intended structure may be related as an assembly.

Although system 100 may be used to develop designs and cost data for insulated panel structures for a variety of applications, an application for a refrigeration walk in structure will be described herein by way of example and completeness of description.

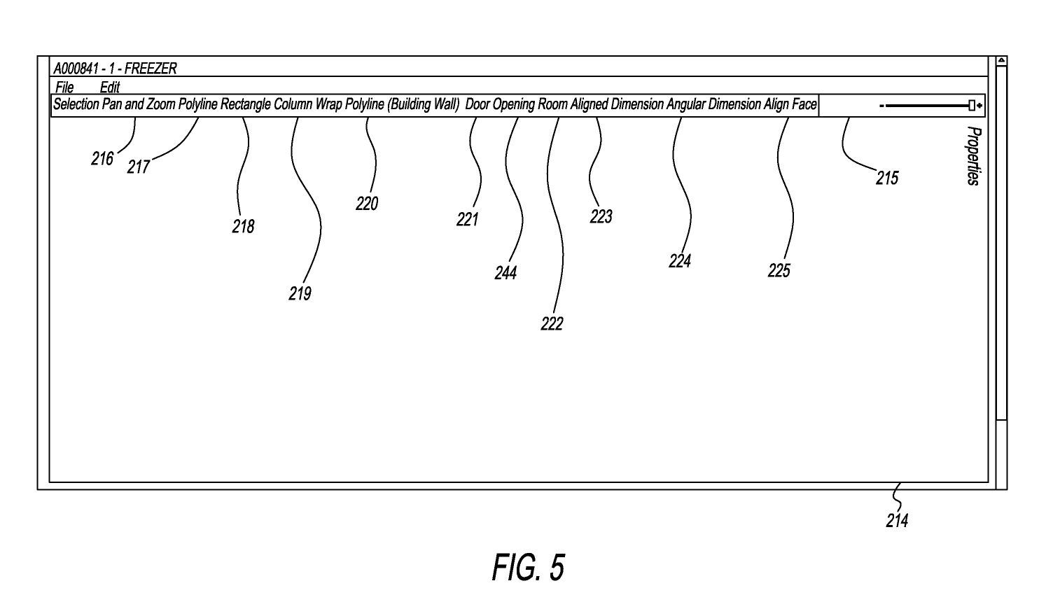

Referring to FIG. 5, upon receipt of a request, quoter 140 may then activate quote/sketch program 212 by logging in, and exercising some freedom in the order of addressing inputs for editing an existing quotation, or creating a new quotation for describing a structure to be built from insulated panels. A screen 214 is presented on display 202 at this time for log in using any suitable security measures. A banner 215 comprises a set of tabs for sketch options that include a pan and zoom tab 216, a polyline tab 217, a rectangle tab 218, a column wrap tab 219, a polyline (building wall) tab 220, a door tab 221, an opening tab 244, a room tab 222, an aligned dimension tab 223, an angular dimension tab 224 and an align face tab 225.

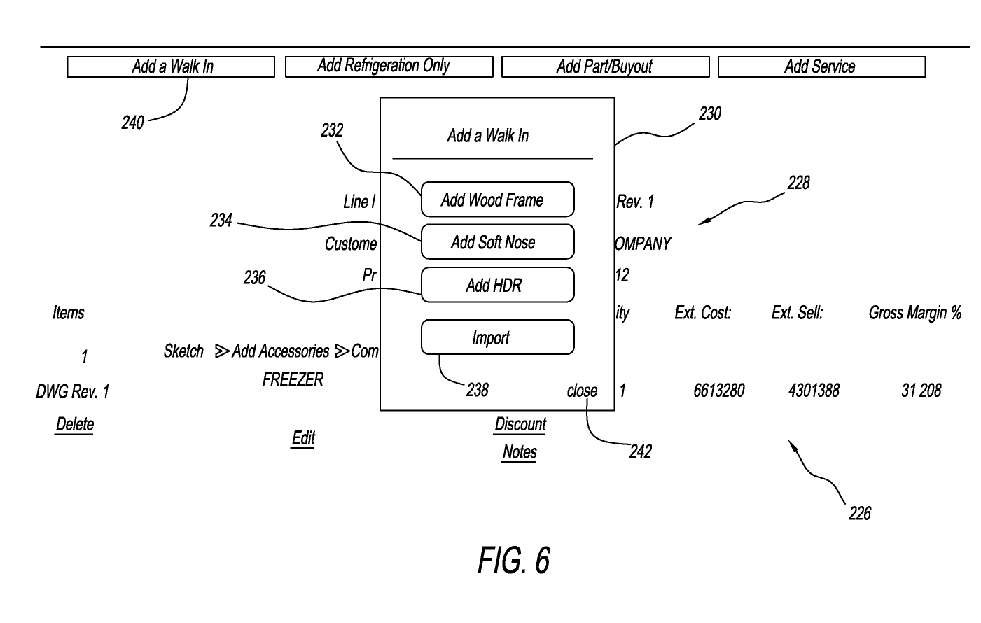

Referring to FIG. 6, after logging in, quoter 140 enters a customer identity 228, for example, ABC Company, in a dialog box 226, which may be presented on screen 214 or another screen. Dialog box 226 comprises a set of tabs that includes an add walk-in tab 240, which is selected by the user. Quote/sketch program 212 then presents a dialog box 230 for add walk-in on screen 214. Dialog box 230 includes selections add wood frame 232, add soft nose 234 and add HDR (High Density Rail) 236, which if selected will be added to the insulated panel structure design. An import button 238 is provided. Quoter 140 selects add soft nose 234. Upon completing the selections, quoter 140 clicks on a close button 242.

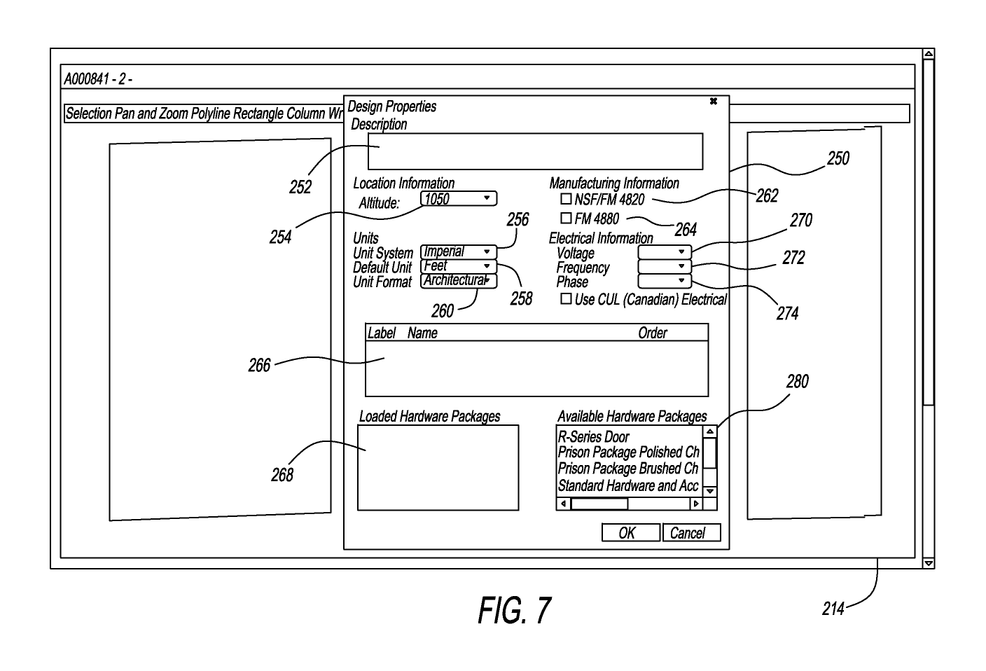

Referring to FIG. 7, a dialog box 250 is presented on screen 214 that contains fields for user entry of design properties. These fields include a description field 252 and a field 266. An altitude field 254 allows user entry of an altitude of the site where the refrigeration walk in structure will be located. A unit field allows user selection of a unit system 256, of a default unit 258 and of a unit format 260. A manufacturing field allows user selection of an industry standard (for example NSF/FM 4820) device 262 or a fire wall protective (for example, F14 4580) device 264. An electrical information field allows user selection of values for a voltage 270, a frequency 272 and a phase 274. A field 268 allows user entry of loaded hardware packages. A field 280 allows user entry of available hardware packages. Upon completion of the entries, quoter 140 clicks on OK.

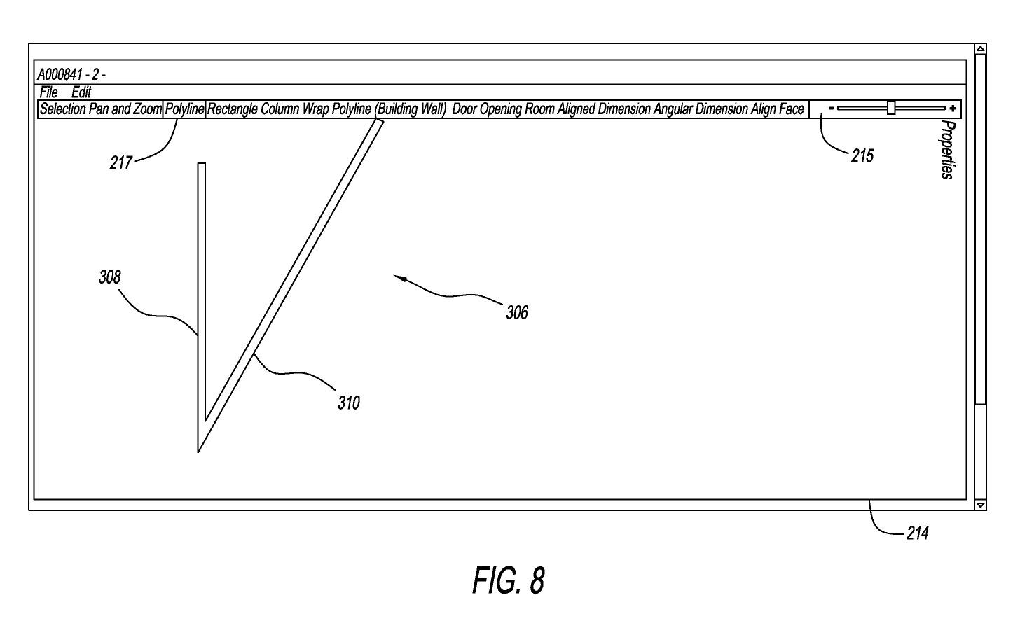

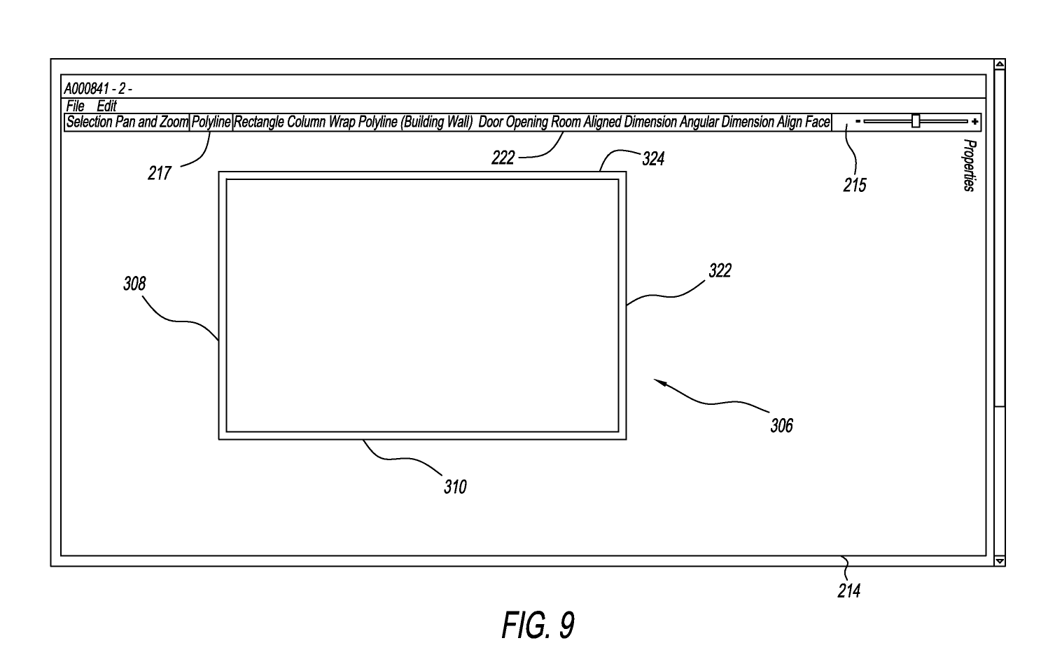

Referring to FIGS. 8 and 9, quoter 140 selects polyline tab 217 from banner 215 for the illustrated example. Quoter 140 is then enabled to sketch on screen 214 a design sketch 306 using the polyline option polyline tab 217. Quoter 140 sketches design sketch 306 using a cursor with a select and drag operation. A wall 308 and a wall 310 are drawn as shown in FIG. 7. Wall 310 is rotated to the horizontal by a click and drag operation and walls 322 and 324 are similarly drawn to form a rectangular room or compartment for design sketch 306 as shown in FIG. 9. Quote sketch program 212 calculates connection points for snap lines and guides for design sketch 306. Quoter 140 decides at this time to designate the enclosed space of design sketch to be a room or a compartment. Quoter 140 selects room tab 222 on banner 215 and clicks on the enclosed area of design sketch 306. This results in an identification of the enclosed area being one compartment of a multi-compartment structure.

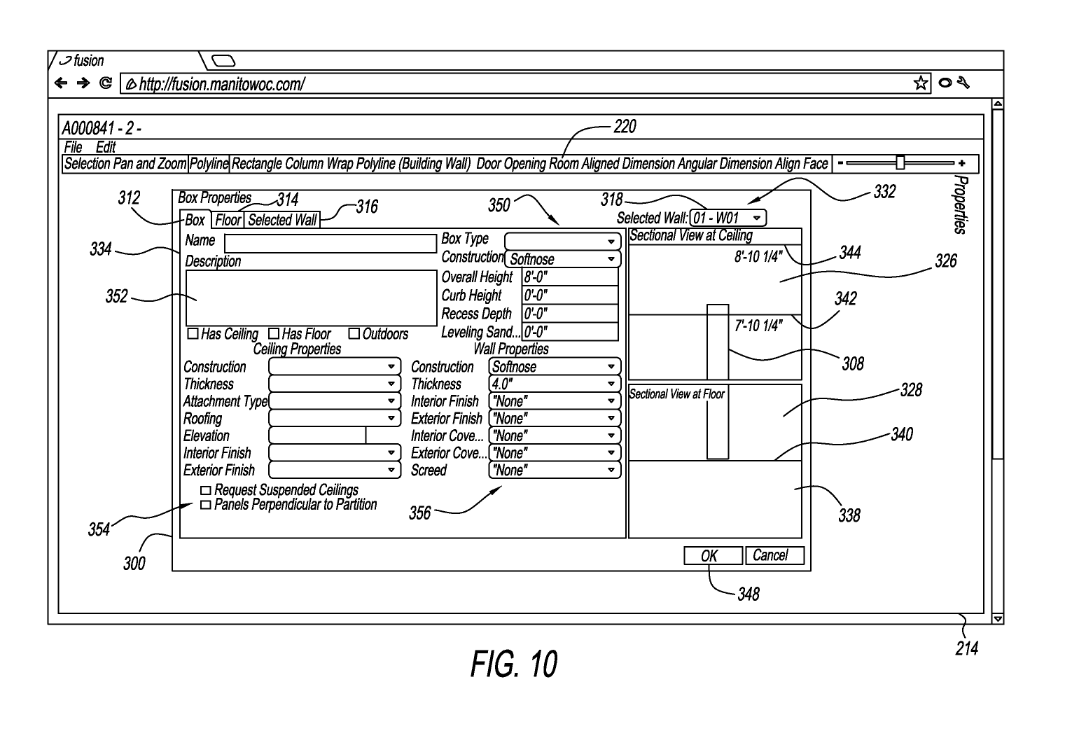

Referring to FIG. 10, quoter 140 is presented with a dialog box 300 for entry of various data to describe the compartment. Dialog box 300 includes an area 332 and an area 334. Area 334 has a box tab 312, a floor tab 314 and a wall tab 316. Quoter 140 selects wall tab 316. Area 332 comprises a selected wall box 318, a space 326, a space 328 and a space 338. Space 326 is labeled sectional view at the ceiling. Space 328 is labeled sectional view at the floor. Space 338 is below a ground level 340. Area 334 comprises a box type area 350, a description area 352, a ceiling property area 354, and a wall properties area 356. As quoter 140 had previously selected soft nose construction from dialog box 230 in FIG. 6, quote/sketch program 212 automatically inserts a construction type of soft nose in construction boxes of box type area 350 and wall properties area 356.

Quoter 140 enters a selected wall 308 (01-W01) in selected wall box 318, an elevational sectional view of wall 308 is then displayed in spaces 326 and 328. This elevational view of wall 308 is derived from considerations of panel thickness, centerline tagging and wall to floor junction. In space 326, a first elevation level 342 and a second elevation level 344 are disposed and correspond to available manufacturing elevations or heights for an insulated panel. Choosing either first elevation level 342 or second elevation level 344 provides economic benefits of an available manufacture that can be shared with the customer. Quoter 140 chooses first elevation level 342 and enters a height of 8 feet in an overall height box of box type area 350 and a wall thickness of 4 inches in wall properties area 356. Quoter 140 selects room tab 220. Quoter 140 clicks on OK button 348.

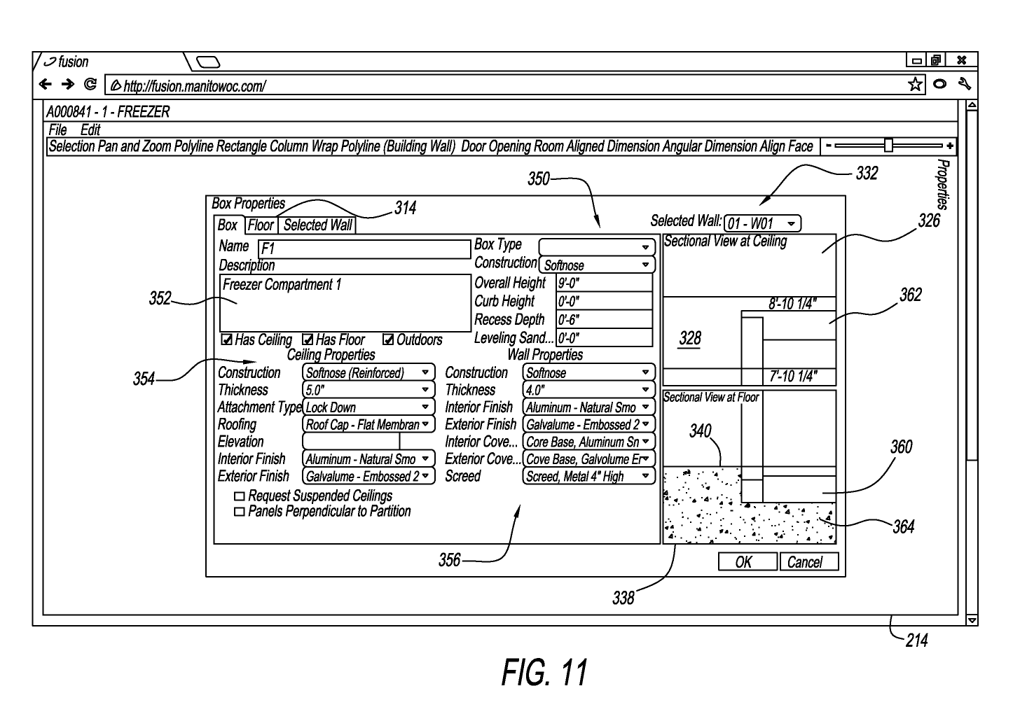

Referring to FIG. 11, quote/sketch program 212 inserts a name “Freezer Compartment 1” in description area 352, inserts parameters in the boxes of ceiling properties 354 and of wall properties area 356, changes the overall height from 8 feet to 9 feet in area 350 and inserts a recess depth of 6 inches in area 350. Quoter 140 clicks on floor tab 314. A floor 360 and a ceiling 362 are added to the sectional view by quote/sketch program 212. As shown in FIG. 11, floor 360 is below ground level 340 and space 338 is filled with cement 364. The user may also apply these data entries to the entire box by selection of its respective tab. The user clicks on OK.

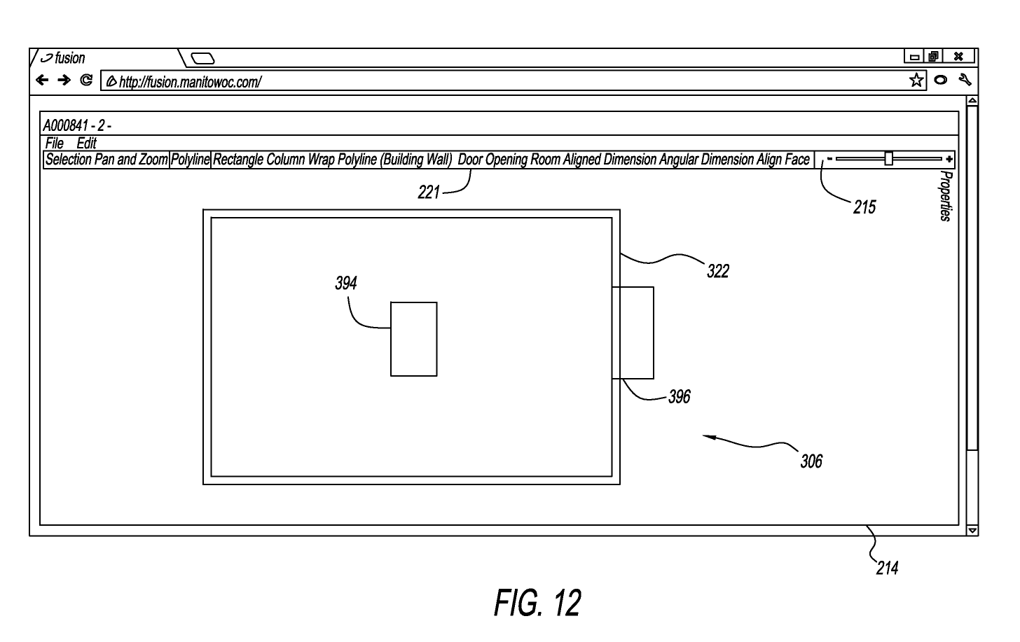

Referring to FIG. 12, quoter 140 clicks on door tab 221 of banner 215. Quote/sketch program 140 presents on display screen 214 design sketch 306 with a door icon 394. Quoter 140 using a pointer to select door icon 394 and drag it to a door location 396 on wall 322. The pointer, for example, may be a mouse, a joy stick, a wand, or even a finger.

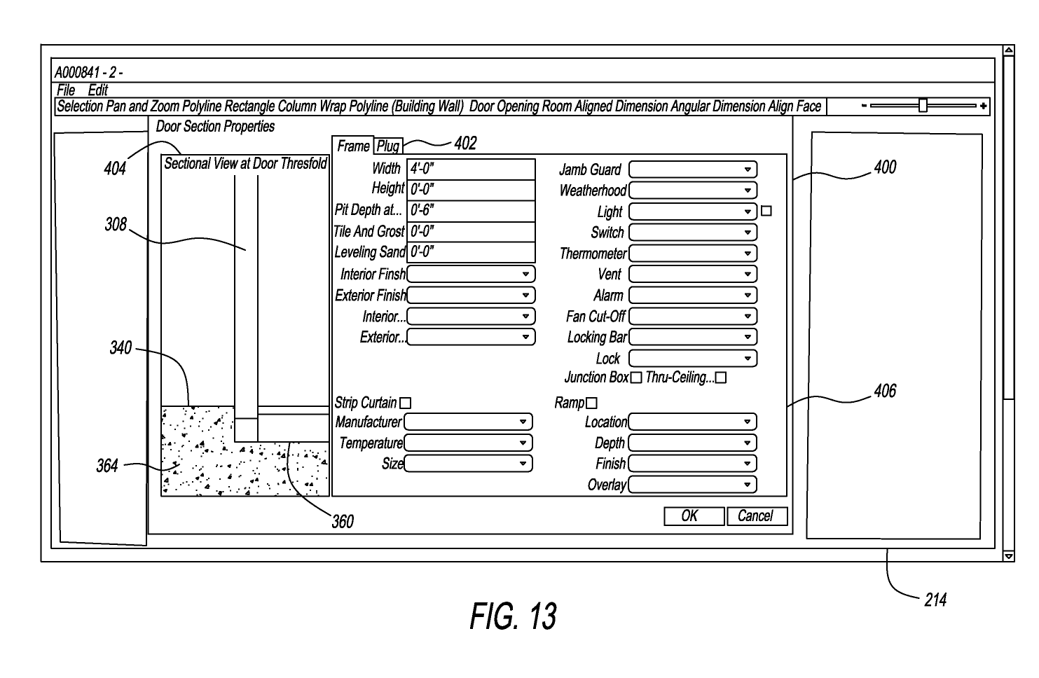

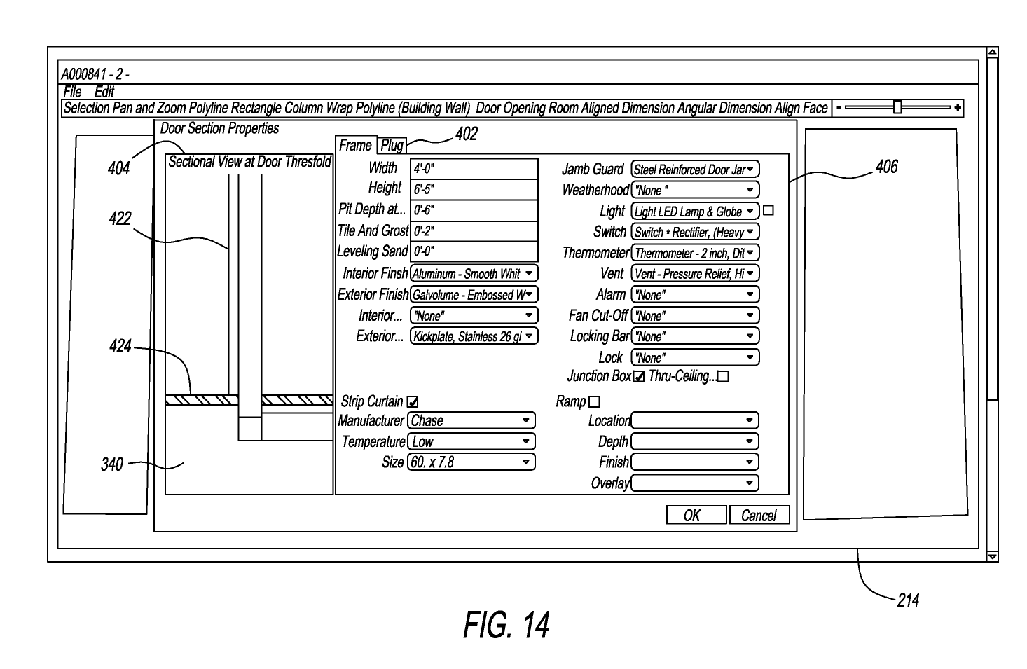

Referring to FIGS. 13 and 14, when door location 396 has been established, quote/sketch program 140 presents a dialog box 400 on display screen 214 for door section properties. Dialog box 400 comprises a space 404 and a data entry space 406. An elevational view of wall 308 for a door threshold with visual cues to aid the user in describing the door is disposed in space 404. The visual cues assist quoter 140 by indicating visually that the door height does fit or not fit on a wall or reaches the floor (desirable) or extends beyond the top (undesirable) and many other concerns that would be hard for quoter 140 to remember or imagine due to complex differences among various structures. As quoter 140 enters descriptive parameters of a door 422 in data entry space 406, quote/sketch program 140 automatically updates the visual cues. As shown, a tile and grout 424 is added to the elevational view as the user makes an entry in data entry space 406.

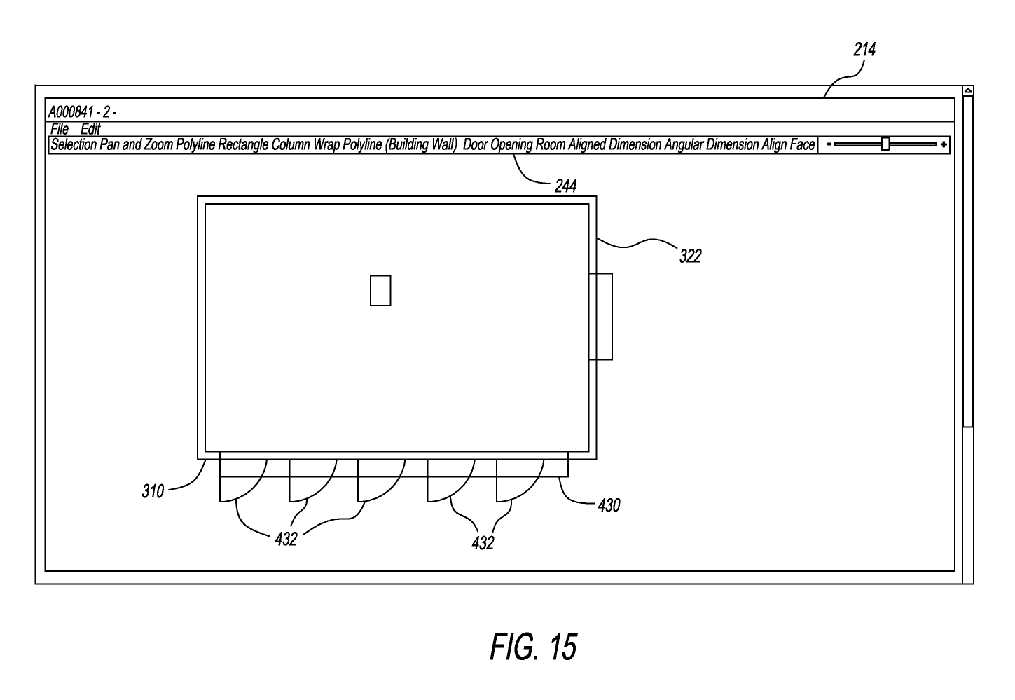

Referring to FIG. 15, quoter 140 selects an opening tab 244 to add an opening 430 in wall 310 of design sketch 306. A pop up box (not shown) appears for the user to describe one or more reach in doors 432 for opening 430. Quoter 140 elects to save design sketch 306 as freezer compartment 1 (see description area 352 in FIG. 11), by clicking on file and on a save selection (not shown).

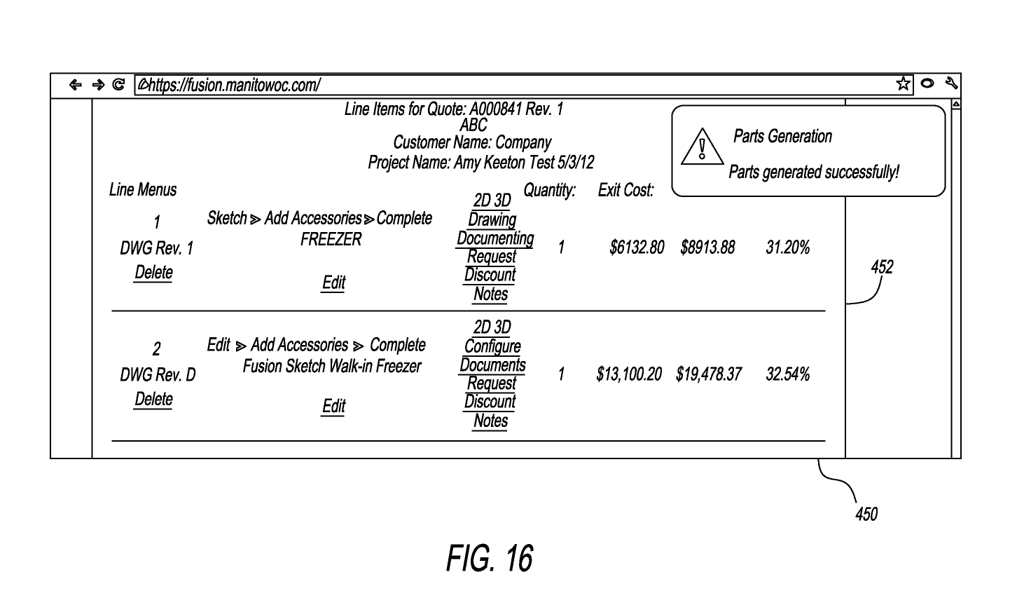

Referring to FIG. 16, a screen 450 shows a quotation record 452 for freezer compartment 1 as added into an existing quote for another freezer for ABC Company. During the save and update operation, quote/sketch program 212 activates a program module that calculates and optimizes the panels, accessories, fixtures and other materials, obtains freight cost, pricing availability of installer services, verification and sizing of associated refrigeration and applies pricing and discounts.

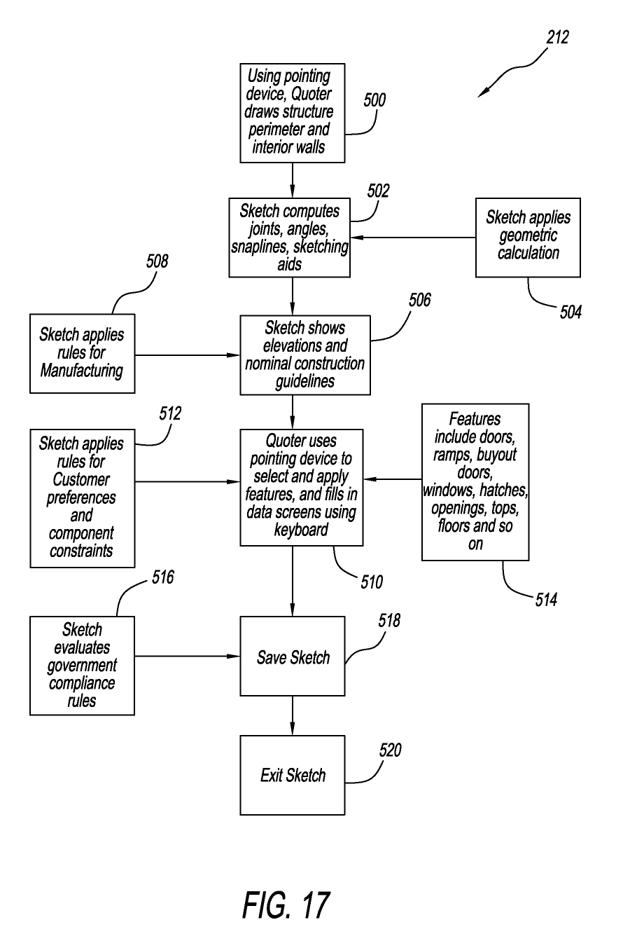

Referring to FIG. 17, quote sketch program 212 comprises instructions that when executed by processor 200 permit quoter 140 at box 500 to use a pointer to draw the perimeter and interior walls of a panel structure on a display screen 214 as shown in FIGS. 8 and 9. At box 502, joints, angles, snaplines and sketching aids are calculated. At box 504, a geometric equation is applied to the panel structure. At box 506, instructions executed by processor 200 present dialog boxes 300 and 308 (FIGS. 10 and 11) on display 202 that show elevational views of walls and nominal constructional guidelines. At box 508, instructions executed by processor 200 apply rules for manufacturing to the panel structure. At box 510, instructions executed by processor 200 allow quoter 140 to use the pointer to select and apply features and to fill in data screens using a keyboard or other entry device as shown in FIGS. 9-11. At box 512, instructions executed by processor 200 apply rules for customer preferences and component restraints. At box 514, instructions executed by processor 200 provide a display in dialog boxes 12-14 of features that include doors, ramps, buyout doors, windows, hatches, openings, tops, floors and others. At box 516, instructions executed by processor 200 provide an evaluation of government compliance rules for the panel structure. At box 518, the sketch of the panel structure is saved to database server 122. At box 520 quote/sketch program 520 is exited.

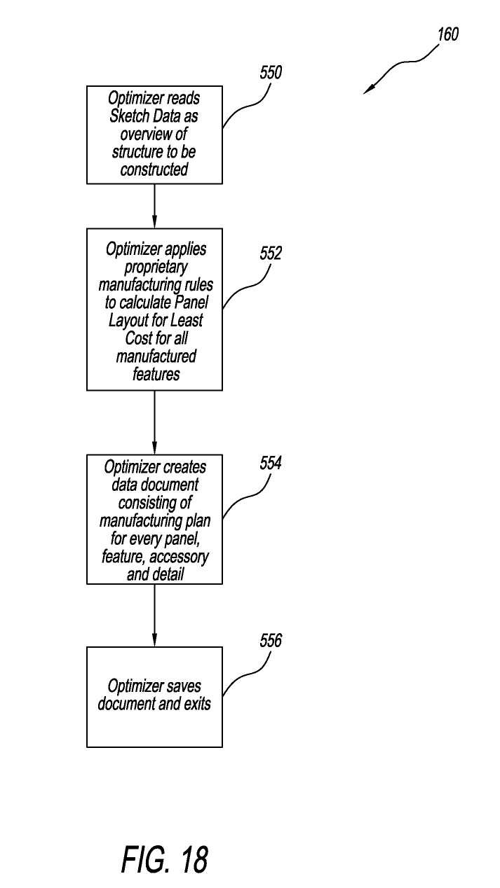

Referring to FIG. 18, optimizer program 160 comprises instructions that when executed by a processor in server 118 provide the activities described in boxes 550, 552, 554 and 556. At box 550, the sketch data of the construction plan is received from quote/sketch program 212 as noted at box 146 of FIG. 2. At box 552, manufacturing rules are used in a calculation of a panel layout for least cost for all manufactured features or parts. At box 554, a data document is developed comprising a manufacturing plan for every panel, feature, accessory and detail of the construction plan. At box 556, the construction plan is saved to database server 122 and optimizer program 160 is exited.

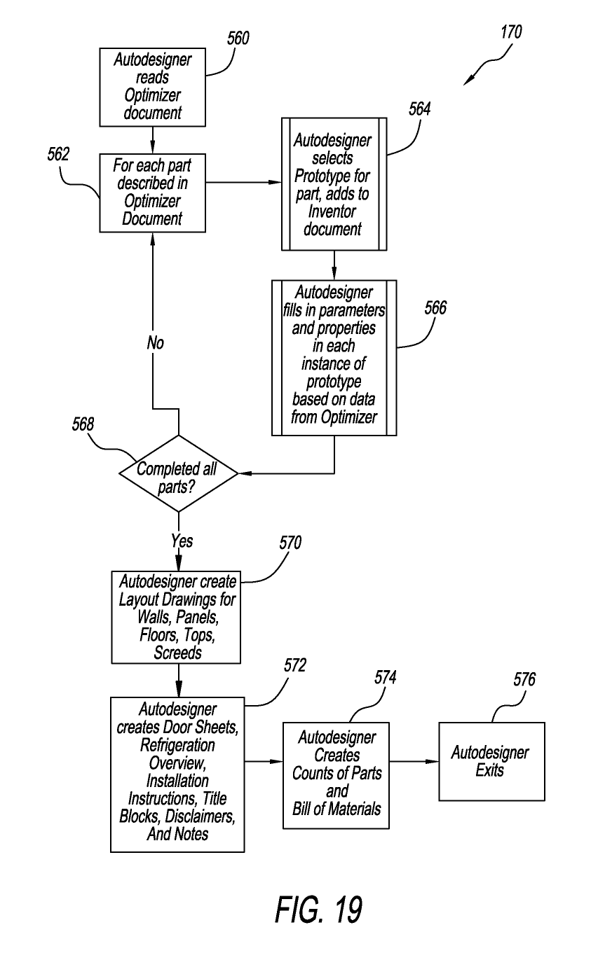

Referring to FIG. 19, auto-design program 170 comprises instructions that when executed by processor 200 in user terminal device 120 provide the activities shown in the depicted boxes. At box 560, the data document depicted in boxes 554 and 556 of optimizer program 160 is accessed. At box 562, a part of the panel layout described in the data document is presented to box 564. A prototype for the part is added to the data document. At box 566, parameters and properties in each instance of the prototype are filled in based on data in the data document. At box 568, it is determined if all parts of the panel layout have been completed, if not the activities of boxes 562, 564 and 566 are repeated for each remaining part of the panel layout. When all of the parts have been completed, at box 570 layout drawings for walls, panels, floors, tops and screeds are developed. At box 572, the layout drawings for door sheets, refrigeration overview, installation instructions, title blocks, disclaimers and notes are developed. At box 574, counts of parts and a bill of materials is developed. At box 576 auto-design program 170 is exited.

The system and method of the present disclosure has several benefits that include (1) a reduction in labor costs in creating the quotation and drawing package, (2) a reduction in costs of materials and manufacturing item by optimizing as the construction plan is developed, (3) a reduction in iterations of correspondence, saving time and labor with accurate descriptions of item to be manufactured and (4) a reduction in errors and costs of warranty and replacement of parts by improved communication among the customer, the quoter, the designer and the manufacturing team.

The present disclosure having been thus described with particular reference to the preferred forms thereof, it will be obvious that various changes and modifications may be made therein without departing from the scope of the present disclosure as defined in the appended claims.

What is claimed is:

1. A system for development of a design for an insulated panel structure, comprising:
one or more user terminal devices that interact via a network with one or more computing devices and with a user to execute program instructions to provide a sketch of said insulated panel structure, and to provide, based on said sketch, a construction plan.

2. The system of claim 1, wherein a first one of said terminal devices comprises a user interface with a display and tools for the user to draw said sketch including walls, tops, or floors to form one or more rooms of said insulated panel structure.

3. The system of claim 2, wherein said program instructions comprise sketch instructions that, when executed, (a) enable the user to select and apply features to the sketch and (b) compute joints, angles, snaplines of said sketch.

4. The system of claim 3, wherein said features include one or more of doors, ramps, buyout doors, windows, hatches and openings for said insulated panel structure.

5. The system of claim 4, wherein said program instructions, when executed, develop said construction plan for said sketch in which manufacturing rules are applied to said sketch to determine a panel layout for least cost for all manufactured features, and wherein said construction plan and said panel layout are optimized by identifying parts, panels and accessories for creating said insulated panel structure and by determining costs and prices for the parts and panels, shipping and tax charges.

6. The system of claim 5, wherein said sketch comprises walls, tops, floors or features or accessories, and wherein said program instructions, when executed, create a data document that comprises a manufacturing plan for said walls, tops, floors or features or accessories.

7. The system of claim 6, wherein said construction plan and panel layout are further optimized by considering the altitude of the site where the insulated panel structure will be located and by selecting said parts and panels based on said altitude.

8. The system of claim 1, wherein there is further provided, based on said construction plan, an engineering drawing, and to provide, based on said engineering drawing, manufacturing orders for said insulated panel structure.

9. The system of claim 8, wherein said program instructions, when executed, create said engineering drawing by importing prototypes for parts listed in said data document, filling in parameters and properties of the prototypes of said parts, creating layout drawings, installation instructions, door sheets and refrigeration sheets.

10. The system of claim 9, wherein said program instructions, when executed, creates manufacturing orders with a bill of materials, hardware box plans and submission files for said insulated panel structure.

11. The system of claim 1, wherein said insulated panel structure comprises a refrigerated walk in structure.

12. A method for development of an insulated panel structure comprising:
executing program instructions to provide a sketch of said insulated panel structure; and
executing program instructions to provide, based on said sketch, a construction plan for said insulated panel structure.

13. The method of claim 12, further comprising:
executing said program instructions to interact with a user to draw said sketch including walls, tops, or floors to form one or more rooms of said insulated panel structure.

14. The method of claim 13, further comprising:
executing said program instructions for (a) enabling the user to select and apply features to the sketch and (b) computing joints, angles, snaplines of said sketch.

15. The method of claim 14, wherein said features include one or more of doors, ramps, buyout doors, windows, hatches and openings for said insulated panel structure.

16. The method of claim 15, further comprising:
executing said program instructions to provide, based on said sketch, a panel layout for said insulated panel structure and to optimize said construction plan and said panel layout by identifying parts, panels and accessories for creating said insulated panel structure and by determining costs and prices for the parts and panels, shipping and tax charges.

17. The method of claim 16, wherein said construction plan and panel layout are further optimized by considering the altitude of the site where the insulated panel structure will be located and by selecting said parts and panels based on said altitude.

18. The method of claim 17, further comprising:
executing said program instructions for creating a data document that comprises a manufacturing plan for said walls, tops, floors or features or accessories.

19. The method of claim 12, further comprising:
executing program instructions to provide, based on said construction plan, an engineering drawing; and
executing program instructions to provide, based on said engineering drawing, manufacturing orders for said insulated panel structure.

20. The method of claim 19, further comprising:
executing said program instructions for creating said engineering drawing by importing a prototype for parts listed in said data document, filling in parameters and properties of the prototype of said parts, creating layout drawings, installation instructions, door sheets and refrigeration sheets.

21. The method of claim 20, further comprising:
executing said program instructions for creating manufacturing orders with a bill of materials, hardware box plans and submission files.

22. The method of claim 12, wherein said insulated panel structure comprises a refrigerated walk-in structure.

23. A user terminal device comprising:
a display;
an input facility for the user to interactively input data concerning said insulated panel structure via said display and to develop on said display a sketch of an insulated panel structure; and
a sketch facility that based on said input data provides on said display an elevational view of said sketch.

24. The user terminal device of claim 23, wherein said sketch facility, based on said input data, automatically changes a height of a wall in said elevational view to match a dimension of available insulated panels.

25. The user terminal device of claim 23, wherein said sketch facility, based on said input data, adds to said elevational view one or more features comprising a door, a ramp, a window, a hatch, an opening, a top, a floor and accessories.

26. The user terminal device of claim 25, wherein said sketch facility, based on said input data, enables said user to identify a location on said sketch for placement of one or more of said features.

27. A method for developing a design of an insulated panel structure comprising
interactively with a user terminal inputting data concerning said insulated panel structure via a display of said user terminal;
sketching on said display a sketch of an insulated panel structure; and
providing on said display an elevational view of said sketch.

28. The method of claim 27, further comprising:
automatically changing a height of a wall in said elevational view to match a dimension of available insulated panels.

29. The method of claim 27, further comprising:
adding to said elevational view one or more features comprising a door, a ramp, a window, a hatch, an opening, a top, a floor and accessories.

30. The method of claim 27, further comprising:
enabling said user to identify a location on said sketch for placement of one or more of said features.

31. A non-transitory computer readable medium storing one or more programs for a system that develops a design for an insulated panel structure, said memory media comprising:
executable with a computer apparatus instructions of said one or more programs to provide a sketch of said insulated panel structure, and to provide, based on said sketch, a construction plan.

32. The non-transitory computer readable medium of claim 31, further comprising:
executable with said computer apparatus instructions of said one or more programs to interact with a user to draw said sketch including walls, tops, or floors to form one or more rooms of said insulated panel structure.

33. The non-transitory computer readable medium of claim 32, further comprising:
executable with said computer apparatus instructions of said one or more programs for (a) enabling the user to select and apply features to the sketch and (b) computing joints, angles, snaplines of said sketch.

34. The non-transitory computer readable medium of claim 33, wherein said features include one or more of doors, ramps, buyout doors, windows, hatches and openings for said insulated panel structure.

35. The non-transitory computer readable medium of claim 31, further comprising:
executable with said computer apparatus instructions of said one or more programs for applying manufacturing rules to said sketch to determine a panel layout for least cost for all manufactured features while providing said construction plan.

36. The non-transitory computer readable medium of claim 35, further comprising:
executable with said computer apparatus instructions of said one or more programs for creating a data document that comprises a manufacturing plan for said walls, tops, floors or features or accessories.

37. The non-transitory computer readable medium of claim 35, further comprising:
executable with said computer apparatus instructions of said one or more program to provide, based on said construction plan, an engineering drawing and to provide, based on said engineering drawing, manufacturing orders for said insulated panel structure.

38. The non-transitory computer readable medium of claim 37, further comprising:
executable with said computer apparatus instructions of said one or more programs for creating said engineering drawing by importing prototypes for parts listed in said data document, filling in parameters and properties of the prototypes of said parts, creating layout drawings, installation instructions, door sheets and refrigeration sheets.

39. The non-transitory computer readable medium of claim 37, further comprising:
executable with said computer apparatus instructions of said one or more programs for creating said manufacturing orders with a bill of materials, hardware box plans and submission files.

40. A non-transitory computer readable medium storing one or more programs for a system that develops a design for an insulated panel structure, said memory media comprising:
executable with a computer apparatus instructions of said one or more programs for the user to interactively input data concerning said insulated panel structure via a display and to develop on said display a sketch of an insulated panel structure; and
executable with said computer apparatus instructions of said one or more programs to provide, based on said input data, on said display an elevational view of said sketch.

41. The non-transitory computer readable medium of claim 40, further comprising:
executable with a computer apparatus instructions of said one or more programs for automatically changing a height of a wall in said elevational view to match a dimension of available insulated panels.

42. The non-transitory computer readable medium of claim 41, further comprising: executable with a computer apparatus instructions of said one or more programs for adding to said elevational view one or more features comprising a door, a ramp, a window, a hatch, an opening, a top, a floor and accessories.

43. The non-transitory computer readable medium of claim 42, further comprising:
executable with a computer apparatus instructions of said one or more programs for enabling said user to identify a location on said sketch for placement of one or more of said features.
